(19) United States
(12) Patent Application Publication
(10) Pub. No.: US 2008/0018671 A1
(43) Pub. Date: Jan. 24, 2008

(54) Information Display Control Device, Navigation Device, Controlling Method Of Information Display Control Device, Control Program Of Information Display Control Device, And Computer-Readable Storage Medium

(75) Inventors: Aki Miake, Nara-shi (JP); Yoshiyuki Murashima, Yamatotakada-shi (JP); Takeshi Yamamoto, Soraku-gun (JP); Toshiya Takahashi, Soraku-gun (JP); Shinichirou Ota, Nara-shi (JP); Megumi Itoh, Nara-shi (JP)

Correspondence Address: SHARP KABUSHIKI KAISHA;C/O KEATING & BENNETT, LLP, 8180 GREENSBORO DRIVE, SUITE 850, MCLEAN, VA, 22102, US

(73) Assignee: SHARP KABUSHIKI KAISHA, Osaka-shi, Osaka (JP)

(21) Appl. No.: 11/570,051

(22) PCT Filed: Jun. 3, 2005
(86) PCT No.: PCT/JP05/10637

§ 371 Date: Dec. 5, 2006

(30) Foreign Application Priority Data
Jun. 7, 2004 (JP) 2004-169148

(51) Int. Cl. G01C 21/36; G09B 29/00; G09B 29/10

(52) U.S. Cl. 345/661; 345/660

(57) ABSTRACT

An image data obtaining section reads out map information displayed in a display device from a map information storage section and converts the map information into image data so as to cause an image data storage memory to store the image data, and a changing display control section reads out the image data and causes the display device to scale down or scale up the image data, and a determined size information generation section reads out the map information from the map information storage section and converts the map information into determined size information by adjusting a scale-down or scale-up factor of the map information to a display scale factor specified in a scale-down or scale-up determination instruction given by a user, and a determined display control section causes the display device to display the determined size information, thereby realizing an information display control device which can convert information displayed in the display device into information, which is accurately displayed and can be scaled down or scaled up at a display scale factor desired by the user, with simple operation which allows the user to glimpse.

### BACKGROUND OF THE INVENTION

1. Field of the Invention

The present invention relates to an information display control device, a navigation device, a controlling method of the information display control device, a control program of the information display control device, and a computer-readable storage medium, whereby information is displayed.

2. Description of the Related Art

Recently, various navigation devices installed onto automobiles have been being developed. Further, mobile communication terminals such as mobile phones having navigation functions have been being developed. Such navigation devices have various functions so as to provide high quality services to users. However, a map displayed in the navigation device has such a problem that: when the map is scaled down or scaled up, a range of the map becomes narrower (more detailed) or wider (more extensive), but a letter size in the map is neither scaled down nor scaled up. Thus, it is hard for an elderly person or the like to recognize letters in the map without any glasses. In order to solve the problem, for example, Japanese Unexamined Patent Publication No. 183181/1999 (Tokukaihei 11-183181)(Publication date: Jul. 9, 1999) recites a navigation device whose usability and visibility are improved so as to cover ages of users. An age of a user is inputted, so that the navigation device provides image navigation information and sound navigation information by means of a display color, a contrast, a letter size, a map scale, and an alarm frequency, all of which correspond to the age of the user.

However, according to the navigation device recited in Tokukaihei 11-183181, a manner in which the information is provided may be inappropriate for a user because of individual difference. Further, Tokukaihei 11-183181 is totally silent about a technique in which a map scale and a letter size are easily changed in a short time as the user desires. Further, Japanese Unexamined Patent Publication No. 296511/1999 (Tokukaihei 11-296511)(Publication date: Oct. 29, 1999) recites an electronic device which allocates fonts in case of displaying letters indicative of information. However, the electronic device raises such a problem that: a manner in which letters are displayed is not necessarily preferred by the user.

Further, there is a navigation device which allows a size of displayed letters to be selected irrespective of scaling down and scaling up of the map. However, its letter size can be selected merely from 9P to 12P at most. It is impossible to select a size which can drastically solve such a problem that the displayed letters are hard to recognize. Further, such a navigation device mainly adopts a mode in which a multistage button is touched so as to scale down or scale up the map. Thus, the user has to repeatedly touch the button in selecting a map having a desired scale. This is not preferable in terms of efficiency. Further, in terms of safety, it is dangerous that it takes long time to select the map while driving an automobile.

Particularly, a navigation device which is seen while driving an automobile is required to provide a display condition which can be roughly recognized at a glance. Further, in the navigation device, it is difficult to install a high level CPU such as a personal computer CPU, so that an easy method for realizing a quick process is desired.

Meanwhile, there is a diagram drawing function or the like of a personal computer or the like which function allows a diagram having letters to be scaled down or scaled up. It is general that: in case of scaling down or scaling up a diagram having letters in a display screen, the diagram is scaled down or scaled up but letters are neither scaled down nor scaled up as shown in FIG. 7(a). In order to solve such a problem, as shown in FIG. 7(b), the diagram (vector data) having letters is converted into an image (image data), thereby scaling up not only the diagram but also the letters. However, as shown in FIG. 7(c), in case of performing a scale-down or scale-up operation (zooming) with a mouse or the like, it is only a rectangle showing an outline that is scaled down or scaled up at a real time, and the diagram and the letters therein are not displayed in the display screen at a real time. Thus, in a redrawing operation upon determining to zoom the map, the user is informed of a degree to which the diagram and the letter have been scaled down or scaled up. Thus, it is actual that the user has to repeat the operation several times so as to adjust the scale until a desired size is obtained.

Further, in case where it is possible to change a display scale factor at which an entire diagram having letters is scaled down or scaled up and then is displayed, the user selects a display scale factor in terms of a display percent such as 100%, 75%, and 50%. Thus, after the display scale factor is selected and the diagram is redrawn, the user has to change the display scale factor several times so as to obtain a desired display condition in such a case that: the diagram should be further scaled up even though a scale factor at which the diagram is scaled up is not clear. This is inconvenient for the user. Likewise, also map information indicated by the diagram having letters cannot be converted smoothly. This raises such a problem that: the user cannot grab, at a glance, a degree to which the diagram should be scaled up or scaled down.

The present invention was made in view of the foregoing problems, and an object of the present invention is to provide an information display control device, a navigation device, a controlling method of the information display control device, a control program of the information display control device, and a computer-readable storage medium, whereby it is possible to convert information displayed in a display section into information, which is accurately displayed and can be scaled down or scaled up at a display scale factor desired by a user, with so simple operation as to allow the user to glimpse. Further, an object of the present invention is to allow the user to see a scale-down or scale-up operation concerning information displayed in the display section.

### SUMMARY OF THE INVENTION

In order to solve the foregoing problem, an information display control device according to the present invention includes: information display control means for causing display information read out from an information providing section to be displayed in a display section; image data obtaining means for converting at least the display information displayed in the display section into image data so as to cause an image data storage section to store the image data; changing display control means for reading out the image data from the image data storage section and for scaling down or scaling up the image data so as to display the image data in the display section in response to a scale-down or scale-up changing instruction given by a user; determined size information generation means for reading out the display information from the information providing section so as to convert the display information into determined size information by adjusting a scale-down or scale-up factor of the display image to a display scale factor specified in the scale-down or scale-up determination instruction given by the user; and determined display control means for causing the display section to display the determined size information.

Further, in order to solve the foregoing problem, an information display control device according to the present invention includes: display total control means for causing display information read out from an information providing section to be displayed in a display section; and image data obtaining means for converting at least the display information displayed in the display section into image data so as to cause an image data storage section to store the image data, wherein: the display total control means reads out the image data from the image data storage section and scales down or scales up the image data so as to display the image data, instead of the display information, in the display section in response to a scale-down or scale-up changing instruction given by a user, and the display total control means reads out the display information from the information providing section and causes the display section to display, instead of the image data, determined size information obtained by converting the display information by adjusting a scale-down or scale-up factor of the display image to a display scale factor specified in the scale-down or scale-up determination instruction given by the user.

Further, in order to solve the foregoing problem, a method according to the present invention for controlling the information display control device includes the steps of: causing display information read out from an information providing section to be displayed in a display section; converting at least the display information displayed in the display section into image data so as to cause an image data storage section to store the image data; reading out the image data from the image data storage section and scaling down or scaling up the image data so as to display the image data in the display section in response to a scale-down or scale-up changing instruction given by a user; reading out the display information from the information providing section so as to convert the display information into determined size information by adjusting a scale-down or scale-up factor of the display information to a display scale factor specified in the scale-down or scale-up determination instruction given by the user; and causing the display section to display the determined size information.

Here, the display scale factor specified in the scale-down or scale-up determination instruction is a display scale factor at which the image data is displayed at the time when the determination instruction has been given.

According to the foregoing arrangement and the foregoing method, the display information is converted into the image data, and the image data is scaled down or scaled up. Further, when the display scale factor has been determined, the display section converts the display information into determined size information obtained by adjusting a scale-down or scale-up factor of the display information to a display scale factor. Therefore, it is possible to convert the information displayed in the display section into information, which is displayed accurately and can be scaled down or scaled up at a display scale factor desired by a user, with so simple operation as to allow the user to glimpse. Further, when the image data is scaled down or scaled up in response to such operation that the user gives the scale-down or scale-up changing direction, the user can obtain information, scaled down or scaled up at a display scale factor desired, in a short time, while confirming an actual display scale factor of the display information at a real time. Note that, the image data is a single image indicative of display information.

Further, a time taken to display an image in this case is shorter than a time taken to read out the display information from the information providing section and display the information after changing a size of the information. Thus, the user can see how the image data is scaled down or scaled up in the display section, so that it is possible to obtain information having a desired size while confirming the size of the display information. Further, the determined size information obtained by converting a display scale factor of display information read out from the information providing section again is displayed, so that it is possible to obtain information, which is displayed accurately and is easy to see. Note that, the display information may be letter data, graphic data, or diagram data. Alternatively, the display information may be a combination of letter data, graphic data, and diagram data. Further, in the display information, the letter data may be vector font data or dot font data. Here, the vector font data is such that: an outline of a single letter is constituted of (i) apex coordinate data and (ii) function data indicative of straight and curve lines. Note that, the dot font data is such that dots constitute a single letter. Further, in the display information, graphic data is used as image data and the diagram data is used as vector data.

Further, in order to solve the foregoing problem, a navigation device according to the present invention includes: the information display control device according to the present invention; a map information storage section serving as the information providing section for providing the map information as the display information; a display section controlled by the information display control device; an input section which allows an instruction given by the user to be inputted to the information display control device; and an image data storage section.

According to the arrangement, the map information is converted into image data, and the image data is scaled down or scaled up so as to be displayed. Further, in the display section, the map information is converted into determined size information corresponding to a display scale factor at the time when the display scale factor has been determined. Therefore, it is possible to convert the map information into information, which is displayed accurately and can be scaled down or scaled up at a display scale factor desired by the user, with so simple operation as to allow the user to glimpse. Further, when the image data is scaled down or scaled up in response to a scale-down or scale-up changing instruction given by the user, the user can obtain information, scaled down or scaled up at a display scale factor desired, in a short time, while confirming an actual display scale factor of the display information at a real time. Thus, even when a user is driving a vehicle, it is possible to rapidly and easily display map information, displayed accurately, which has been scaled down or scaled up at a display scale factor appropriate for any user.

Note that, the information display control device according to the present invention may be realized by a computer. In this case, the present invention includes also (i) a control program causing the information display control device to operate, wherein the foregoing means are realized by a computer, and (ii) a computer-readable storage medium, storing the control program.

According to the foregoing arrangement, the control program of the information display control device is read out and is executed by a computer, thereby realizing the same effects as in the information display control device.

For a fuller understanding of the nature and advantages of the invention, reference should be made to the ensuing detailed description taken in conjunction with the accompanying drawings.

### BRIEF DESCRIPTION OF DRAWINGS

FIG. 1, showing one embodiment of the present invention, is a block diagram showing important portions of a navigation device.

FIG. 2 is a flowchart showing how map information made of graphic data in the navigation device of FIG. 1 is scaled down or scaled up.

FIG. 3 shows a range of the map information converted into image data by an image data obtaining section in the navigation device of FIG. 1.

FIG. 4 is a flowchart showing how map information made of letter data and graphic data in the navigation device of FIG. 1 is scaled down or scaled up.

FIG. 5 is a flowchart showing how map information whose letter data is made of a vector font in the navigation device of FIG. 1 is scaled down or scaled up.

FIG. 6 is a flowchart showing how display information in an information processing device having an information display control device of the present embodiment is scaled down or scaled up.

FIG. 7(a) to FIG. 7(c) show a mode in which a diagram having letters is displayed in scaling down or scaling up the diagram in accordance with a conventional diagram drawing function or the like.

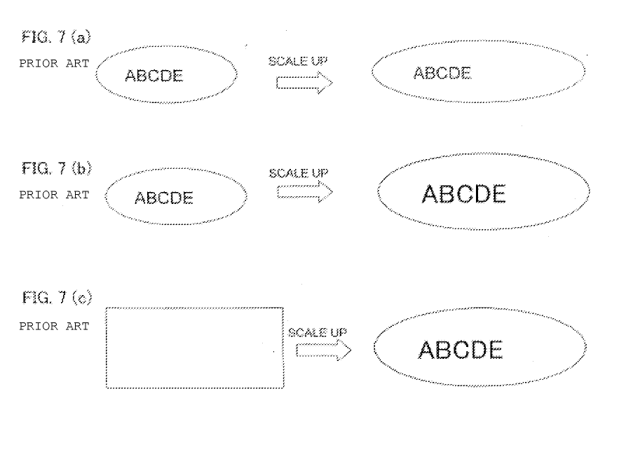

### DETAILED DESCRIPTION OF PREFERRED EMBODIMENTS

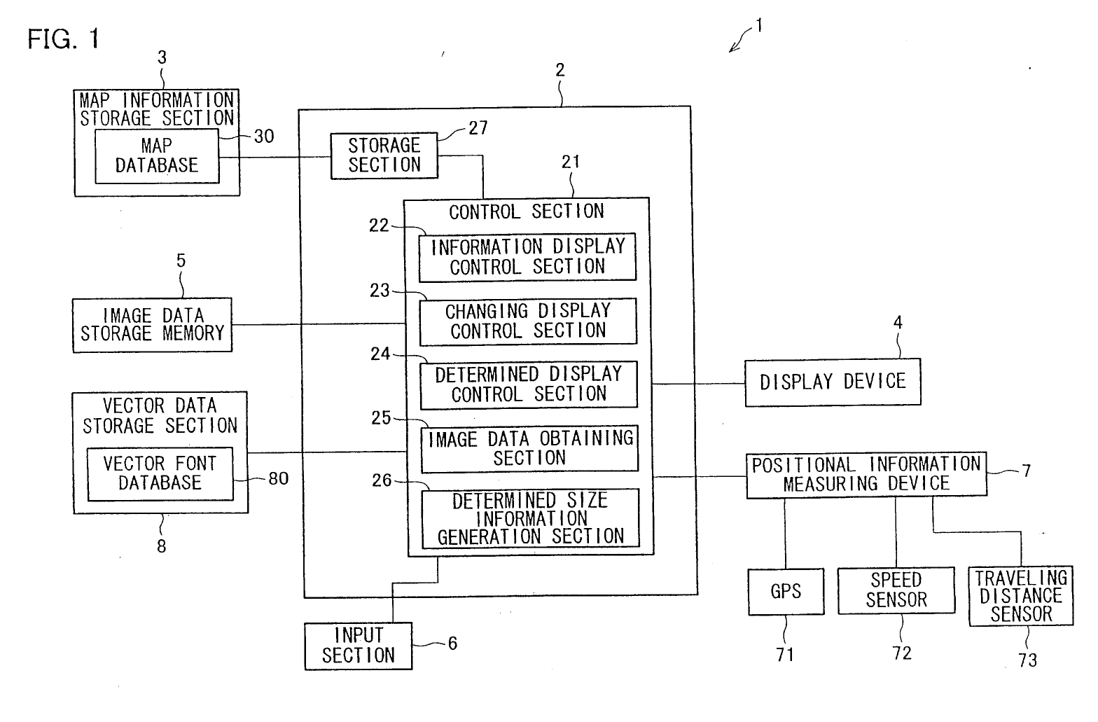

The following description will explain one embodiment of the present invention with reference to FIG. 1 to FIG. 6. Note that, the following embodiment gives explanation supposing that the information display control device according to the present invention is used as a part of an arrangement of the navigation device, but the use of the information display control device is not limited to this.

FIG. 1 is a block diagram showing an arrangement of a navigation device 1 according to the present embodiment. Note that, the navigation device 1 is installed onto a vehicle in the present embodiment, and provides a driver with map information and navigation information or the like attached thereto. Further, the map information means a map and information (for example, names and signs of river, lake, mountain, road, junction, building, bridge, shop, park, parking area, and the like, or a previously stored image for informing a scenic spot or the like) attached to the map.

As shown in FIG. 1, the navigation device 1 includes an information display control section 2, a map information storage section (information providing section) 3, a display device (display section) 4, an image data storage memory (image data storage section) 5, an input section 6, a positional information measuring device (positional information measuring means) 7, and a vector data storage section 8.

The information display control device 2 has a control section 21 and a storage section 27.

The control section 21 totally controls operations of various members in the navigation device 1. Thus, the control section 21 totally controls also operations of various members in the information display control device 2 included in the navigation device 1.

Further, the control section 21 includes: an information display control section (information display control means) 22 for causing the display device 4 to display the map information; a changing display control section (changing display control means) 23 for reading out image data from the image data storage memory 5 so as to cause the display device 4 to scale down or scale up the image data; a determined display control section (determined display control means) 24 for causing the display device 4 to display determined size information; an image data obtaining section (image data obtaining means) 25 for converting the map information read out from the map information storage section 3 into image data so as to cause the image data storage memory 5 to store the image data; and a determined size information generation section (determined size information generation means) 26 for reading out the map information from the map information storage section 3 so as to convert the map information into determined size information by adjusting a scale-down or scale-up factor of the map information to a display scale factor when the user has given a scale-down or scale-up determination instruction. Operations of the members in the control section 21 will be detailed later. Note that, in the control section 21, the information display control section 22, the changing display control section 23, and the determined display control section 24 constitute a single display total control section, and the display total control section (means) may totally control the display.

Further, in the present embodiment, each member of the control section 21 processes the map information as detailed later, but can processes also display information as well as the map information. Note that, the display information is information displayed by the display device 4, e.g., (i) map information read out from a map database 30 of the map information storage section 3 via the storage section 27, (ii) positional information indicative of the current position measured by the positional information measuring device 7, and (iii) navigation information based on the positional information. The display information is not limited to them, but may be any information as long as the information can be displayed by the display device 4. The display information may be information received from the outside.

The control section 21 is constituted of a CPU (Central Processing Unit) for example. However, the control section 21 may be constituted of a PC-base computer. Further, operations of members in the navigation device 1 are controlled by causing a computer to execute a control program. The program may be stored in a ROM (Read Only Memory) or may be stored in a removable medium such as a CD-ROM and be read out, or may be installed in a hard disk and be read out. Further, in case where the control section 21 is connected to a communications network such as the Internet, it may be so arranged that the program is downloaded and is installed into a hard disk or the like so as to be executed.

The storage section 27 is constituted of a nonvolatile storage device such as a RAM (Random Access Memory), a flash memory, or a hard disk. Examples of contents stored in the storage section 27 include: the aforementioned control program; other kinds of programs; map information read out from the map database 30 of the map information storage section 3; and the like.

The map information storage section 3 is storage means which stores the map database 30 serving as a database of the map information, and provides the control section 21 with the map information via the storage section 27 in response to an instruction from the control section 21. The map information storage section 3 is constituted of a hard disk, but the arrangement is not limited to this. For example, it may be so arranged that: the map information is previously stored in a magnetic tape, such as a video tape and a cassette tape; a magnetic disk such as a floppy disk (registered trademark); an optical disc (an optical magnetic disk), such as a CD-ROM/MO/MD/DVD/CD-R; a memory card, such as an IC card and an optical card; and a semiconductor memory, such as a mask ROM, an EPROM, an EEPROM, or a flash ROM, and thus stored map information is read out. Further, as shown in FIG. 1, the map database 30 may be stored in the map information storage section 3 separately from the storage section 27, or may be stored in the storage section 27. Alternatively, in case where the navigation device 1 has a communication section and is connected to a communications network such as the Internet, the map database 30 may be downloaded from the outside via the communication network. Alternatively, it may be so arranged that the map information is downloaded and used.

The display device 4 is display means for displaying display information such as: the map information read out from the map database 30; positional information indicative of the current position measured by the positional information measuring device 7; and navigation information based on the positional information or the like. Note that, a display screen of the display device 4 may be a liquid crystal panel, but is not limited to this. As long as the map information, the navigation information, or the like can be displayed, it is possible to use an organic EL (Electro Luminescence) panel, a plasma display panel, a CRT (Cathode Ray Tube), and the like. Further, the display screen of the display device 4 may be installed as an instrument panel, or may be provided separately from an instrument panel.

The image data storage memory 5 temporarily stores as image data the map information read out by the image data obtaining section 25, and is constituted of a volatile storage device.

The input section 6 receives an instruction from the user and transmits the instruction to the control section 21. The input section 6 has a plurality of input keys/buttons, and the user can give various instructions to the navigation device 1 of the present embodiment via the input keys/buttons.

Note that, the display device 4 may be used as the input section 6. That is, for example, it may be so arranged that the input section 6 and the display screen of the display device 4 are integrated to each other so as to form a touch panel. In this case, the display screen of the display device 4 displays items which can be inputted by the driver, and the driver touches a display area in which a desired item is displayed, so that an instruction is given to the control section 21. Alternatively, a mouse or a stick-shape operation device may be provided as the input section 6. Further, an operation input section of an audio system or the like may be used also as the input section 6. Further, in case of providing a system for electrically adjusting an angle or the like of a side mirror (wing mirror), these operation means may be used also as the input section 6.

The positional information measuring device 7 includes: a GPS 71 for analyzing a current position (latitude, longitude, altitude) in accordance with a GPS positioning signal received from a positioning satellite via a GPS antenna; speed sensor 72 for measuring a speed of a vehicle; and a traveling distance sensor 73 for measuring a distance in which a vehicle travels. Note that, the members of the positional information measuring device 7 are only examples and the arrangement is not limited to them. The positional information measuring device 7 transmits the obtained positional information to the control section 21. The positional information may be obtained as follows: the GPS 71 is used so as to detect a current position of the vehicle; or a current position of the vehicle is detected in accordance with so-called self navigation in which variation of the current position is followed on the basis of start point information, a direction in which an automobile or the like travels, a traveling speed, a traveling distance, and the like. Note that, a manner in which the positional information is obtained is not limited to them.

The vector data storage section 8 is storage means which stores a vector font database 80 which is a database of letter data of a vector font. The vector data storage section 8 provides the letter data of the vector font to the control section 21 via the storage section 27 in response to an instruction from the control section 21.

Further, although not shown, the navigation device 1 may include, for example: a voice input section by which the user inputs a voice; a voice operation guide; a voice output section for giving traveling information; a communication section via which the navigation device 1 transmits or receives data to or from the outside or other communication device. Further, the navigation device 1 has a function for providing basic navigation information (traveling guide information), but description thereof is omitted here.

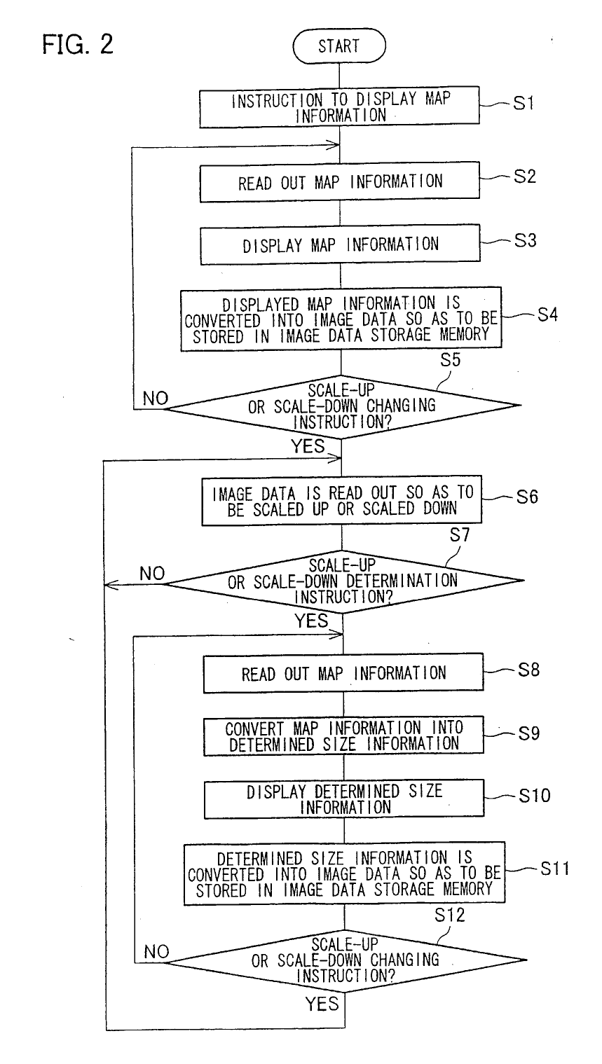

Next, with reference to FIG. 2, the following description explains how the map information is scaled up or scaled down in the navigation device 1. FIG. 2 is a flowchart showing how the map information is scaled up or scaled down. Note that, the following description exemplifies the map information including, as display information subjected to the scale-up or scale-down operation, at least any one of letter data, graphic data, and diagram data. However, the display information is not limited to the map information. As long as the information includes at least any one of letter data, graphic data, and diagram data, it is possible to perform the following scale-up or scale-down operation with respect to the information. The display information may be received from the outside as long as the information can be displayed in the display device 4.

As shown in FIG. 2, first, when a power supply of the navigation system 1 is turned ON and the program starts up, the control section 21 gives an instruction to display the map information in a step 1 (hereinafter, steps are referred to as S1 or in a similar manner), and the process proceeds to S2.

In S2, the information display control section 22 reads out the map information from the map information database 30 of the map information storage section 3 via the storage section 27. Further, in S3, the information display control section 22 causes the display device 4 to display thus read out map information. Further, the information display control section 22 displays a mark indicative of the vehicle's position, measured by the positional information measuring device 7, in a map based on the map information displayed by the display device 4.

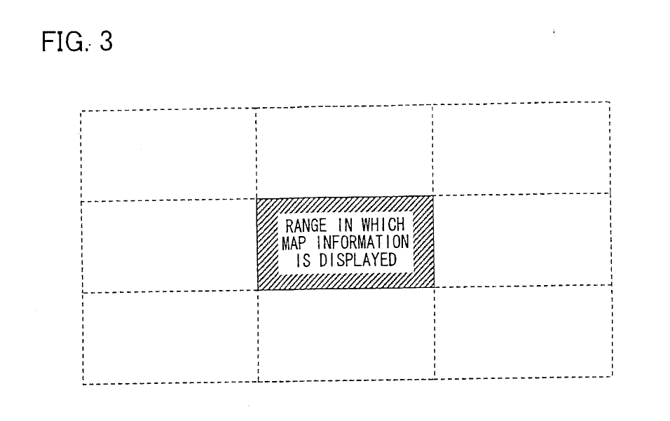

In S4, the image data obtaining section 25 converts the map information (inclusive of the mark indicative of the vehicle's position) indicated by the display device 4 into image data, and causes the image data storage memory 5 to store the image data. The image data is an image indicative of the display information in the display section. Here, in case of converting the map information into the image data and storing the image data, the image data obtaining section 25 converts not only the map information displayed in the display device 4 but also map-peripheral information into image data and causes the image data storage memory 5 to store the image data. Also the map-peripheral information is stored in the image data storage memory 5 in this manner, so that it is possible to display scaled-down map-peripheral information together at the time of a scale-down operation (described as follows) performed with respect to the map information. Further, it is possible to scroll the map smoothly. Note that, in this case, as shown in FIG. 3 for example, not only the map information displayed in the display device 4 but also map information having the same display area in vertical and horizontal directions and in diagonally vertical and horizontal directions is converted into image data, and the image data is stored in the image data storage memory 5. Note that, the steps S3 and S4 may be inversely performed or may be performed at the same time.

In the present embodiment, the image data obtaining section 25 always converts the map information into the image data when the map information is read out from the map information storage section 3. However, the conversion may be performed at the time when the user has pushed a scale-down or scale-up button of the input section (a scale-down or scale-up changing instruction has been inputted). In this case, when the scale-up button has been pushed, the image data obtaining section 25 may cause the image data storage memory 5 to store only the map information displayed in the display device 4. When the scale-up button has been pushed (a scale-up changing instruction has been inputted), the scaled-up map information is displayed, so that information other than the information displayed in the display device 4 before the scale-up operation is not necessary. Thus, as described above, the map information displayed in the display device 4 is stored without any modification. By storing information in this manner, the information display control device 2 can realize a high speed process and it is possible to scale down or scale up the information at a real time. Thus, it becomes easier for the user to confirm the map information displayed.

In S5, the control section 21 judges whether or not the user has given a scale-down or scale-up changing instruction with respect to the map information. Here, whether the user has pushed the scale-down or scale-up button of the input section 6 is judged. When it is judged that the changing instruction has been given (YES in S5), the process proceeds to S6. When it is judged that no changing instruction has been given (NO in S5), the process returns to S2. Note that, the display device 4 of the navigation device 1 displays the map information in the whole display screen, and scales down or scales up the whole display screen.

In S6, the changing display control section 23 reads out the image data from the image data storage memory 5, and causes the display device 4 to scale down or scale up the map information in accordance with the scale-down or scale-up changing instruction given by the user. Note that, in case of scaling down the map information, also the map-peripheral information is converted into the image data in S4, so that the changing display control section 23 scales down also the map-peripheral information. In S6, the user keeps on pushing the scale-down or scale-up button of the input section 6 so as to scale down or scale up the map information. By performing such operations, it is possible to scale down or scale up the image data in the display device 4 at a real time.

Further, in case where the display screen of the display device 4 has an area which does not display the image data read out, the changing display control section 23 may cause a background image to be displayed in the area. Due to such display, a background image is displayed in an area which does not display the image data, so that visibility of the image data can be improved. That is, when the previous map information remains in the display screen, this is not preferable in terms of visibility. However, when the background image is displayed, it is possible to erase the previous map information, thereby improving the visibility. In case where the scale-down changing instruction is given for example, when there is an extra display area other than an area corresponding to a range of data stored in the image data storage section, the foregoing arrangement can utilize the extra display area. When a background image colored blue, gray, or the like is displayed in the extra display area, this shows that image data other than the information currently displayed in the display section is not stored in the image data storage memory 5, and it is possible to improve the visibility. Note that, the foregoing background image is only an example.

Note that, the changing display control section 23 may scale down or scale up the image data so that a middle point of the image data stored in the image data storage memory 5 is centered. The image data is scaled down or scaled up so that a middle point of the image data is centered, thereby realizing display whose visibility is high. Alternatively, in case where a mark indicative of the vehicle's current position detected by the positional information measuring device 7 is displayed in the map information on the display screen of the display device 4, the changing display control section 23 may scale down or scale up the image data so that the current position indicated by the mark is centered. When the image data is scaled down or scaled up so that the vehicle's current position is centered, the user can obtain information which allows the user to easily confirm the position, so that this arrangement is highly usable for the user.

In S7, the control section 21 judges whether or not the user has given a scale-down or scale-up determination instruction (a scale-down or scale-up determination instruction has been inputted or not). Here, whether or not the scale-down or scale-up button of the input section 6 has been pushed and released by the user is judged. That is, when the scale-down or scale-up button that had been pushed by the user was released, this is regarded as a determination instruction. When it is judged that the determination instruction has been given (YES in S7), the process proceeds to S8. When it is judged that no determination instruction has been given (NO in S7), the process returns to S6, and the image is kept being scaled down or scaled up.

In S8, the determined size information generation section 26 reads out the map information from the map information storage section 3 via the storage section 27. In S9, the determined size information generation section 26 converts the map information by adjusting a scale-down or scale-up factor of the map information to a display scale factor specified in the scale-down or scale-up determination instruction given by the user so as to obtain map information (determined size information) whose size has been determined. Here, the display scale factor specified in the scale-down or scale-up determination instruction given by the user is a scale factor at which the image data is scaled down or scaled up and is displayed in receiving the determination instruction in S7. In S10, the determined display control section 24 causes the display device 4 to display the map information whose size has been determined.

In S11, the image data obtaining section 25 converts the map information, displayed in the display device 4, whose size has been determined, into image data, and causes the image data storage memory 5 to store the image data. Note that, the steps S10 and S11 may be inversely performed or may be performed at the same time.

In S12, the control section 21 judges whether or not the user has given a scale-down or scale-up changing instruction with respect to the displayed map information. This operation is the same as in S5. When it is judged that the changing instruction has been given (YES in S12), the process returns to S6. When it is judged that no changing instruction has been given (NO in S12), the process returns to S8, and the map information is kept being displayed at the display scale factor specified in the scale-down or scale-up determination instruction given by the user.

In this way, the process in which the map information is scaled down or scaled up in the navigation device 1 is finished. Note that, in S10, the process in which the map information is scaled down or scaled up in the navigation device 1 may be finished. According to the foregoing process, it is possible to convert the map information displayed in the display device 4 into information which is accurately displayed and can be scaled down or scaled up at a display scale factor desired by the user, with simple operation which allows the user to glimpse. Further, in the present embodiment, the image data is scaled down or scaled up in response to input operation by which the user gives the scale-up changing instruction, so that the user can obtain information, which is accurately displayed at a desired display scale factor, in a short time, while confirming an actual display scale factor of the map information at a real time. Further, a time taken to perform such operations is shorter than a time taken to read out the map information from the map information storage section 3 and display the image data after changing the size of the image data. Thus, the user can confirm the size of the image in the display device 4 at a real time and can obtain an image having a desired size. Further, the map information having a size determined by adjusting a scale factor of the map information read out from the map information storage section 3 is displayed again, so that it is possible to obtain accurate information which is easy for the user to see.

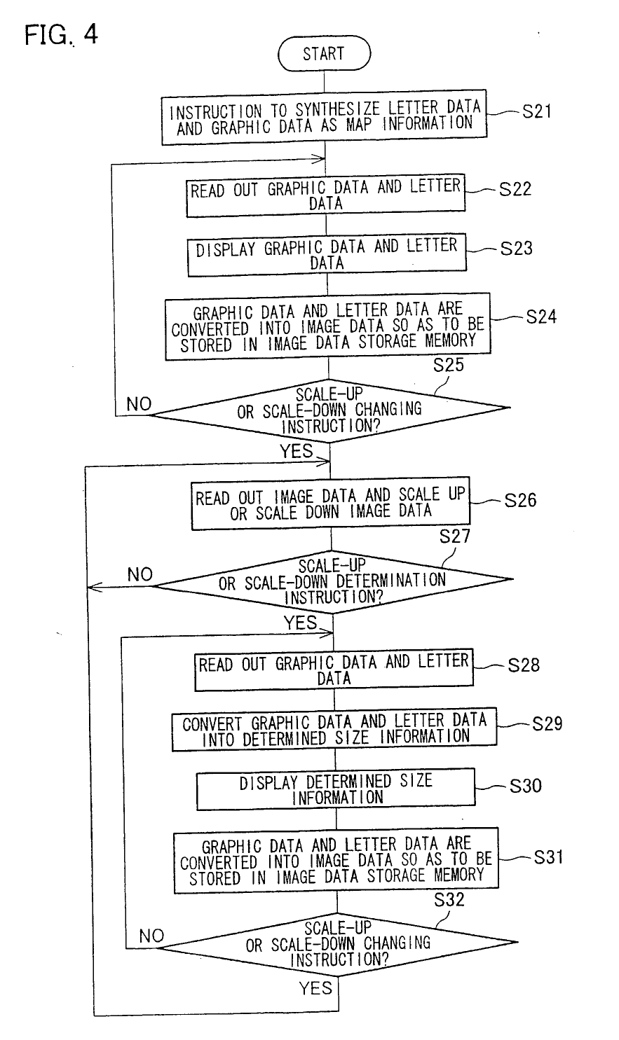

The foregoing description using FIG. 2 did not mention an arrangement of the map information. However, when the map information is constituted of letter data and graphic data, the map information is scaled up or scaled down as follows. FIG. 4 is a flowchart showing how the map information constituted of letter data and graphic data is scaled up or scaled down.

In the flow described by using FIG. 2, the map information is read out and is displayed. In a flow where the map information constituted of letter data and graphic data is scaled up or scaled down, as shown in FIG. 4, the letter data and the graphic data are read out as the map information and they are synthesized and displayed. A flow other than this is the same as in FIG. 2. Thus, description thereof is omitted.

As shown in FIG. 4, first, when a power supply of the navigation system 1 is turned ON and the program starts up, the control section 21 gives an instruction to synthesize the letter data and the graphic data as the map information in S2 1 and the process proceeds to S22.

In S22, the information display control section 22 reads out the letter data and the graphic data as the map information from the map information database 30 of the map information storage section 3 via the storage section 27. Further, in S23, the information display control section 22 causes the display device 4 to display thus read out letter data and graphic data. Further, the process proceeds to S24.

In S24, the image data obtaining section 25 converts the letter data and the graphic data, that are displayed in the display device 4, into single image data, and causes the image data storage memory 5 to store the image data. Note that, the steps S23 and S24 may be inversely performed or may be performed at the same time. Then, the process proceeds to S25.

In S25, the control section 21 judges whether or not the user has given a scale-down or scale-up changing instruction with respect to the letter data and the graphic data (the scale-down or scale-up changing instruction has been inputted or not). When it is judged that the changing instruction has been given (YES in S25), the process proceeds to S26. When it is judged that no changing instruction has been given (NO in S25), the process returns to S22.

In S26, the changing display control section 23 reads out the image data from the image data storage memory 5, and causes the display device 4 to scale down or scale up the map information in accordance with the scale-down or scale-up changing instruction given by the user. Further, the process proceeds to S27.

In S27, the control section 21 judges whether or not the user has given a scale-down or scale-up determination instruction with respect to the map information. Here, whether or not the scale-down or scale-up button of the input section 6 has been pushed and released by the user. That is, when the scale-down or scale-up button that had been pushed by the user was released, this is regarded as a determination instruction. When it is judged that the determination instruction has been given (YES in S27), the process proceeds to S28. When it is judged that no determination instruction has been given (NO in S27), the process returns to S26, and the image is kept being scaled down or scaled up.

In S28, the determined size information generation section 26 reads out the letter data and the graphic data from the map information storage section 3 via the storage section 27. In S29, the determined size information generation section 26 converts the letter data and graphic data by adjusting a scale-down or scale-up factor of the letter data and graphic data to a display scale factor specified in the scale-down or scale-up determination instruction given by the user so as to obtain letter data and graphic data whose sizes have been determined. Here, the display scale factor specified in the scale-down or scale-up determination instruction given by the user is a scale factor at which the image data is scaled down or scaled up and is displayed in receiving the determination instruction in S27.

In S30, the determined display control section 24 causes the display device 4 to display the letter data and graphic data whose sizes have been determined.

In S31, the image data obtaining section 25 converts the letter data and graphic data, displayed in the display device 4, whose sizes have been determined, into image data, and causes the image data storage memory 5 to store the image data.

In S32, the control section 21 judges whether or not the user has given a scale-down or scale-up changing instruction with respect to the displayed letter data and graphic data. This operation is the same as in S25. When it is judged that the changing instruction has been given (YES in S32), the process returns to S26. When it is judged that no changing instruction has been given (NO in S32), the process returns to S28, and the map information is kept being displayed at the display scale factor specified in the scale-down or scale-up determination instruction given by the user.

In this way, the process in which the map information constituted of the letter data and graphic data is scaled down or scaled up in the navigation device 1 is finished.

Note that, in the foregoing description, the map information is constituted of the letter data and the graphic data, but the map information may be constituted of letter data, graphic data, and diagram data. In this case, when reading out the map information from the map information database 30 and displaying the map information in the display device 4, letter data, graphic data, and diagram data are synthesized and displayed. Further, it may be so arranged that two of the letter data, the graphic data, and the diagram data are synthesized and displayed, or it may be so arranged that only one of the letter data, the graphic data, and the diagram data is displayed. Further, the determined size information generation section 26 converts the letter data, the graphic data, and the diagram data by adjusting a scale-down or scale-up factor thereof to a display scale factor specified in the scale-down or scale-up determination instruction given by the user so as to obtain letter data, graphic data, and diagram data, whose sizes have been determined.

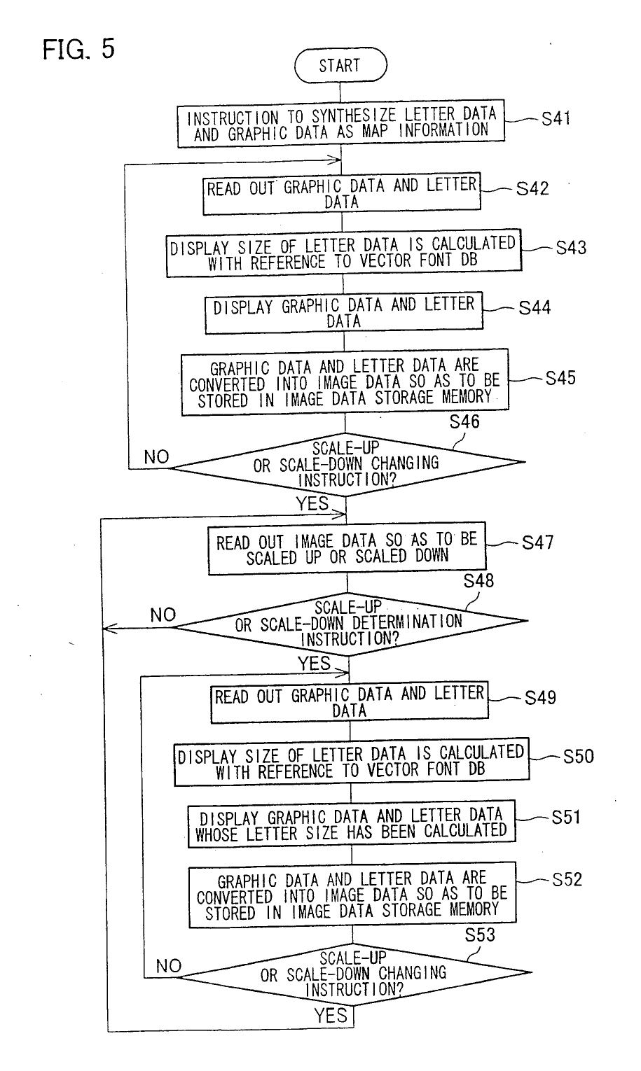

Further, the foregoing description explained, by using FIG. 4, a process in which the map information is scaled up or scaled down in case where the map information is constituted of the letter data and the graphic data. In case where the letter data is vector font data (letter data based on the vector font), the map information is scaled up or scaled down as follows. FIG. 5 is a flowchart showing how the map information whose letter data is based on a vector font is scaled up or scaled down. Here, in addition to the flow explained in FIG. 4, a size of the vector font is calculated. A flow other than this is the same as in FIG. 4. Thus, description thereof is omitted. Note that, the vector font data is constituted of (i) coordinate data indicative of an apex of an outline and (ii) function data indicative of a straight line and a curve, so as to constitute a single letter.

As shown in FIG. 5, first, when a power supply of the navigation system 1 is turned ON and the program starts up, the control section 21 gives an instruction to synthesize the letter data and the graphic data as the map information in S41 and the process proceeds to S42.

In S42, the information display control section 22 reads out the letter data and the graphic data as the map information from the map information database 30 of the map information storage section 3 via the storage section 27. Further, the process proceeds to S43.

In S43, with reference to the vector font database 80, the control section 21 calculates a display size of the letter data read out in S42. In this calculation, the size is calculated so as to be suitable for the display screen of the display device or is calculated as a predetermined display size. The vector font database 80 is stored in a vector data storage section 8 provided in the navigation device 1. The vector data storage section 8 is a hard disk. However, the arrangement is not limited to this. For example, it may be so arranged that: the vector font database 80 is previously stored in a magnetic tape, such as a video tape and a cassette tape; a magnetic disk such as a floppy disk (registered trademark); an optical disc (an optical magnetic disk), such as a CD-ROM/MO/MD/DVD/CD-R; a memory card, such as an IC card and an optical card; and a semiconductor memory, such as a mask ROM, an EPROM, an EEPROM, or a flash ROM, and thus stored vector font database 80 is read out. Further, as shown in FIG. 1, the vector font database 80 may be stored in the vector data storage section 8 separately from the storage section 27, or may be stored in the storage section 27 or the map information storage section 3. Alternatively, when the navigation device 1 is connected to a communications network such as the Internet, the vector font database 80 may be downloaded from the outside via the communications network.

Further, the display size of the letter data of the vector font can be calculated in accordance with a known method. For example, points constituting a letter (for example, a line, a junction, an end or the like of the letter) are replaced with coordinate data, and an interval between the points is changed in the scale-up or scale-down operation, so as to generate a letter having a desired size.

In S44, the information display control section 22 causes the display device 4 to display letter data at a display size calculated in S43. Further, the read out graphic data is displayed. Further, the process proceeds to S45.

In S45, the image data obtaining section 25 converts the letter data and the graphic data, that are displayed in the display device 4, into single image data, and causes the image data storage memory 5 to store the image data. Note that, the steps S44 and S45 may be inversely performed or may be performed at the same time. Then, the process proceeds to S46.

In S46, the control section 21 judges whether or not the user has given a scale-down or scale-up changing instruction with respect to the letter data and the graphic data. When it is judged that the changing instruction has been given (YES in S46), the process proceeds to S47. When it is judged that no changing instruction has been given (NO in S46), the process returns to S42.

In S47, the changing display control section 23 reads out the image data from the image data storage memory 5, and causes the display device 4 to scale down or scale up the image data in accordance with the scale-down or scale-up changing instruction given by the user. Further, the process proceeds to S48.

In S48, the control section 21 judges whether or not the user has given a scale-down or scale-up determination instruction with respect to the map information. When it is judged that the determination instruction has been given (YES in S48), the process proceeds to S49. When it is judged that no determination instruction has been given (NO in S48), the process returns to S47, and the image is kept being scaled down or scaled up.

In S49, the determined size information generation section 26 reads out the letter data and the graphic data as the map information from the map information storage section 3 via the storage section 27. Further, the process proceeds to S50.

In S50, with reference to a vector font database 80, the control section 21 calculates a display size of the letter data read out in S49. The display size is calculated so that the size of the letter data corresponds to a display scale factor specified in the scale-down or scale-up determination instruction given by the user. Note that, the display scale factor specified in the scale-down or scale-up determination instruction given by the user is a display scale factor at which the image data is scaled down or scaled up and is displayed in case where the determination instruction has been given in S48. The vector font is calculated in the same manner as in S43.

In S51, the determined display control section 24 causes the display device 4 to display the letter data and the graphic data whose sizes have been calculated in S50.

In S52, the image data obtaining section 25 converts the letter data and the graphic data, displayed in the display device 4, whose sizes have been determined, into image data, and causes the image data storage memory 5 to store the image data.

In S53, the control section 21 judges whether or not the user has given a scale-down or scale-up changing instruction with respect to the displayed letter data and graphic data. This operation is the same as in S46. When it is judged that the changing instruction has been given (YES in S53), the process returns to S47. When it is judged that no changing instruction has been given (NO in S53), the process returns to S49, and the map information is kept being displayed at the display scale factor specified in the scale-down or scale-up determination instruction given by the user.

In this way, the process in which the map information constituted of the letter data and graphic data is scaled down or scaled up in the navigation device 1 is finished.

Note that, in S50, the determined size information generation section 26 may convert the graphic data, read out in S49, into graphic data whose size is determined by adjusting a scale-down or scale-up factor to a display scale factor specified in the scale-down or scale-up determination instruction given by the user.

Further, in the foregoing description, the letter data of the map information is vector font data. However, it may be so arranged that not all the letter data but a part of the letter data is vector font data. In this case, the display size is calculated as to only the letter data of the vector font.

As described above, when the display size of the letter data of the vector font is calculated, detail and sharpness of an outline of the letter are not lost. Thus, in displaying the determined size information, when the calculated letter data of the vector font is displayed in the display section, it is possible to display information which can be clearly and easily seen.

In the foregoing description, the map information is constituted of the letter data and the graphic data. However, the map information may be constituted of letter data, graphic data, and diagram data. In this case, when reading out the map information from the map information database 30 and displaying the map information in the display device 4, letter data, graphic data, and diagram data are synthesized and displayed. Further, it may be so arranged that two of the letter data, the graphic data, and the diagram data are synthesized and displayed, or it may be so arranged that only one of the letter data, the graphic data, and the diagram data is displayed. Further, the determined size information generation section 26 converts the letter data, the graphic data, and the diagram data by adjusting a scale-down or scale-up factor to a display scale factor specified in the scale-down or scale-up determination instruction given by the user so as to obtain letter data, graphic data, and diagram data, whose sizes have been determined.

Note that, members and steps in the navigation device 1 of the present embodiment are realized as follows: calculation means such as a CPU executes a program stored in storage means such as a ROM (Read Only Memory) and a RAM, and input/output means such as a touch panel or communication means such as an interface circuit is controlled. Thus, a computer having these means merely reads and executes the program stored in the storage medium, thereby realizing various functions and various processes of the navigation device of the present embodiment. Further, the program is stored in a removable storage medium, thereby realizing the various functions and various processes in an arbitrary computer.

Such a computer program storage medium may be a memory (not shown), such as a ROM, so that the process is executable on a microcomputer. Alternatively, a program medium may be used which can be read by inserting the storage medium in an external storage device (program reader device; not shown).

In addition, in either of the cases, it is preferable if the contained program is accessible to a microprocessor which will execute the program. Further, it is preferable if the program is read and then downloaded to a program storage area of a microcomputer where the program is executed. Assume that the program for download is stored in a main body device in advance.

Further, the program medium is a storage medium arranged so that it can be separated from the main body. Examples of such a program medium include a tape, such as a magnetic tape and a cassette tape; a magnetic disk, such as a flexible disk and a hard disk; a disc, such as a CD/MO/MD/DVD; a card, such as an IC card (inclusive of a memory card); and a semiconductor memory, such as a mask ROM, an EPROM (erasable programmable read only memory), an EEPROM (electrically erasable programmable read only memory), or a flash ROM. All these storage media holds a program in a fixed manner.

In addition, if the system is configured to be connectible to a communications network, such as the Internet, it is preferred that the storage medium contains the program in a flowing manner like downloading the program over the communications network.

Further, to download the program over the communications network, it is preferred if the program for download is stored in a main body device in advance or installed from another storage medium.

Note that, the foregoing description explained the case where the navigation device 1 is installed on the vehicle. Examples of the vehicle in the present specification include not only an automobile but also a motorbike, a bicycle, and the like. Further, the navigation device 1 is not limited to a device installed on the vehicle, but can be adopted to various transportation means such as a helicopter, a plane, a ship, and the like. Further, the navigation device 1 is not necessarily fixed on the transport means, but may be installed on the transportation means in a detachable manner.

Further, it may be so arranged that the navigation device 1 can be carried by the user for example. In this case, it may be so arranged that the navigation device 1 can be solely carried, or it may be so arranged that the navigation device 1 is provided on a mobile terminal device such as a mobile phone, PHS (Personal Handyphone System; registered trademark), PDA (Personal Digital Assistant), and a notebook computer, and the like. Of course, the navigation device 1 which can be carried may be placed on each of the transportation means.

Note that, the foregoing embodiment described (i) the case where the information display control device is a part of the navigation device and (ii) the process in which the map information is used as the display information so as to scale up or scale down the display information, but the arrangement is not limited to this. As long as an information processing device includes the information display control device 2, it is possible to obtain substantially the same effect as in the foregoing embodiment. For example, the information display control device 2 may be provided on a personal computer. In this case, it may be so arranged that: the map information storage section 3 shown in FIG. 1 is provided, and the map information is read out from the map information storage section 3. Alternatively, it may be so arranged that another information providing section for providing display information to the control section 21 is installed. Further, as the input section 6, not only input keys/buttons but also a mouse or the like is provided. Note that, the positional information measuring device 7 is not necessarily provided.

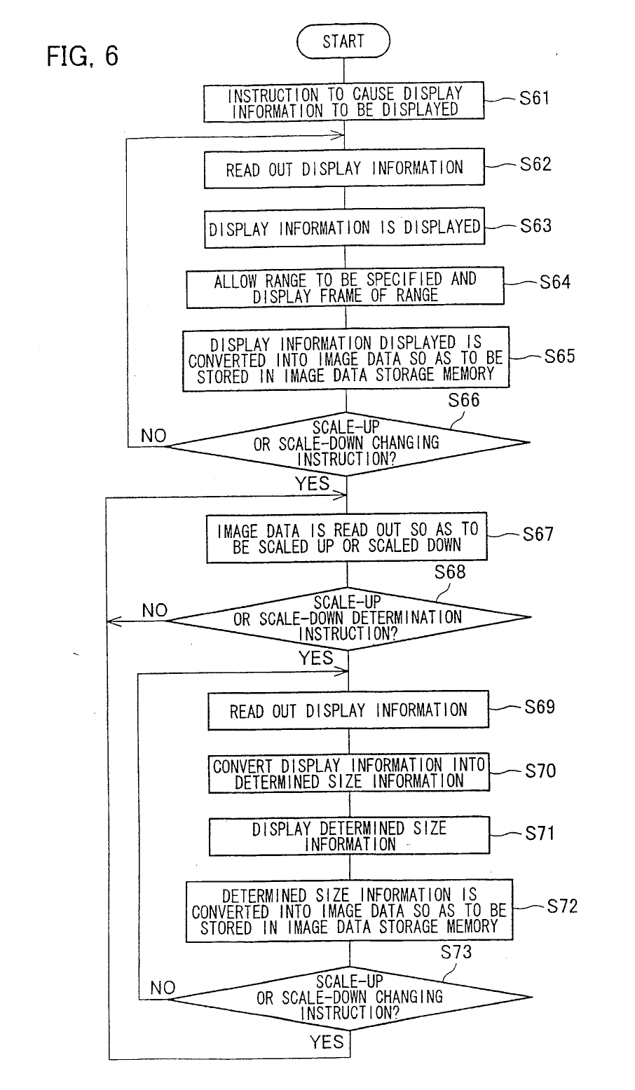

With reference to FIG. 6, the following description explains how the map information is scaled down or scaled up in case where the information display control device 2 is provided on the personal computer.

As shown in FIG. 6, first, the control section 21 gives an instruction to display the display information in S61, and the process proceeds to S62.

In S62, the information display control section 22 reads out the display information from the information providing section. Then, in S63, the information display control section 22 causes the display device 4 to display the read out display information. Further, the process proceeds to S64.

In S64, the control section 21 allows the user to specify a range in which the map information is to be scaled up or scaled down. Here, for example, the user uses a mouse of the input section 6 so as to click a mouse button and drag the range, thereby specifying the range. Other than this, any method for specifying the range may be adopted. When the range is specified, a marker indicative of the specified range (frame of the range) is displayed in the display device 4.

In this manner, an image displayed in the display screen of the display device 4 so as to be positioned in the range entirely or partially selected is scaled down or scaled up.

In S65, the image data obtaining section 25 converts the display information displayed in the display device 4 so as to be positioned in the entirely or partially selected range into image data and causes the image data storage memory 5 to store the image data. Here, the display information is converted into the image data at the time when the user has pushed the scale-down or scale-up button of the input section 6 (the user has given a scale-down or scale-up changing instruction). Alternatively, the display information may be converted at the time when the user has dragged a frame of the range specified in S64.

In S66, the control section 21 judges whether or not the user has given a scale-down or scale-up changing instruction. Here, whether the changing instruction has been given or not is judged in accordance with whether or not the user has begun dragging the frame of the range with the mouse. That is, when the user begins dragging the frame of the range, this is regarded as the changing instruction. When it is judged that the changing instruction has been given (YES in S66), the process proceeds to S67. When it is judged that no changing instruction has been given (NO in S66), the process returns to S62.

In S67, the changing display control section 23 reads out the image data from the image data storage memory 5, and causes the display device 4 to scale down or scale up the image data in accordance with the scale-down or scale-up changing instruction given by the user. In S67, the user keeps dragging the mouse, so that the image data is scaled down or scaled up accordingly. In this manner, it is possible to scale down or scale up the image data at a real time in the display device 4.

In S68, the control section 21 judges whether or not the user has given a scale-down or scale-up determination instruction with respect to the map information. Here, whether the determination instruction has been given or not is judged in accordance with whether or not the user has stopped dragging the frame of the range with the mouse. That is, when the user stops dragging the frame of the range with the mouse, this is regarded as the determination instruction. When it is judged that the determination instruction has been given (YES in S68), the process proceeds to S69. When it is judged that no determination instruction has been given (NO in S68), the process returns to S67, and the image is kept being scaled down or scaled up.

In S69, the determined size information generation section 26 reads out the display information from the information providing section. In S70, the determined size information generation section 26 converts the display information by adjusting a scale-down or scale-up factor of the display information to a display scale factor specified in the scale-down or scale-up determination instruction given by the user so as to obtain display information (determined size information) whose size has been determined. Here, the display scale factor specified in the scale-down or scale-up determination instruction given by the user is a display scale factor at which the image data is scaled down or scaled up and is displayed in receiving the determination instruction in S68.

In S71, the determined display control section 24 causes the display device 4 to display the information whose size has been determined.

In S72, the image data obtaining section 25 converts the information, displayed in the display device 4, whose size has been determined, into image data, and causes the image data storage memory 5 to store the image data.

In S73, the control section 21 judges whether or not the user has given a scale-down or scale-up changing instruction with respect to the displayed display information. This operation is the same as in S66. When it is judged that the changing instruction has been given (YES in S73), the process returns to S67. When it is judged that no changing instruction has been given (NO in S73), the process returns to S69, and the image data is kept being displayed at the display scale factor specified in the scale-down or scale-up determination instruction given by the user.

In this way, the process in which the display information is scaled down or scaled up in the information display control device 2 included in the personal computer is finished.

As described above, an information display control device according to the present invention includes: information display control means for causing display information read out from an information providing section to be displayed in a display section; image data obtaining means for converting at least the display information displayed in the display section into image data so as to cause an image data storage section to store the image data; changing display control means for reading out the image data from the image data storage section and for scaling down or scaling up the image data so as to display the image data in the display section in response to a scale-down or scale-up changing instruction given by a user; determined size information generation means for reading out the display information from the information providing section so as to convert the display information into determined size information by adjusting a scale-down or scale-up factor of the display image to a display scale factor specified in the scale-down or scale-up determination instruction given by the user; and determined display control means for causing the display section to display the determined size information.

In addition to the foregoing arrangement, the information display control device according to the present invention may be arranged so that: when the display information includes vector font data, the determined size information generation means calculates a size of the vector font data so as to correspond to the display scale factor, and converts the vector font data into determined size information having the size that has been calculated.

According to the foregoing arrangement, the size of the vector font data is calculated and is converted into determined size information in redisplaying the display information in the display section as the determined size information, so that detail and sharpness of an outline of the letter are not lost. Thus, in displaying the determined size information, when the calculated letter data of the vector font is displayed in the image display section, it is possible to display information which can be clearly and easily seen. Here, the vector font data is constituted of (i) coordinate data indicative of an apex of an outline and (ii) function data indicative of a straight line and a curve, so as to constitute a single letter.

Further, in addition to the foregoing arrangement, the information display control device according to the present invention may be arranged so that the display information is map information which includes at least any one of letter data, graphic data, and diagram data.

According to the foregoing arrangement, the map information is displayed in the display section, and letter data, graphic data, and diagram data that are included in the map information can be scaled down or scaled up and displayed. Thus, the user can obtain the map information scaled down or scaled up so as to have a desired size which allows the user to easily see the map information. Note that, in the present specification, the map information means a map and information (for example, names and signs of river, lake, mountain, road, junction, building, bridge, shop, park, parking area, and the like, or a previously stored image for informing a scenic spot or the like) attached to the map. Further, the letter included in the map information may be vector font data or dot font data. The image included in the map information is image data, and the diagram included in the map information is vector data.

In addition to the foregoing arrangement, the information display control device according to the present invention may be arranged so that the image data obtaining means causes the image data storage section to store, as image data, not only the map information displayed in the display section but also map-peripheral information indicative of peripheral information of the map information.

The map information includes not only information displayed in the display section but also map-peripheral information is stored in the image data storage section as the image data. According to the foregoing arrangement, it is possible to display scaled-down map-peripheral information together at the time when the map information is scale down. Further, the map can be smoothly scrolled. For example, not only the map information displayed in the display section but also map information having the same display area in vertical and horizontal directions and in diagonally vertical and horizontal directions is stored in the image data storage section as image data.

In addition to the foregoing arrangement, the information display control device according to the present invention may be arranged so that the image data obtaining section causes the image data storage section to store only the display information displayed in the display section.

According to the foregoing arrangement, the display information displayed in the display section is stored as image data without any modification. When a scale-up changing instruction is inputted, the display information is scaled up and displayed, so that information other than the information displayed in the display section before being scaled up is not necessary. Thus, the display information displayed in the display section is merely stored without any modification as described above. According to the foregoing arrangement, it is possible to realize a higher process, so that it is possible to scale down or scale up the image at a faster timing. Thus, the display information becomes easier for the user to confirm.

In addition to the foregoing arrangement, the information display control device according to the present invention may be arranged so that in case where the display section has an area which does not display the image data read out, the changing display control means causes the display section to display an image serving as a background of the area.

According to the foregoing arrangement, a background image is displayed in an area which does not display the image data, so that visibility of the image data can be improved. That is, when the previous display information remains in the display section, this is not preferable in terms of visibility. However, when the background image is displayed, it is possible to erase the previous display information, thereby improving the visibility.

For example, in case where a scale-down changing instruction is given, when there is an extra display area other than an area corresponding to a range of data stored in the image data storage section, a background image colored blue, gray, or the like is displayed in the extra display area. This display condition shows that image data other than the information currently displayed in the display section is not stored in the image data storage section and it is possible to improve the visibility.

In addition to the foregoing arrangement, the information display control device according to the present invention may be arranged so that the changing display control means scales down or scales up the image data so that a middle point of the image data is centered.

According to the foregoing arrangement, the image data is scaled down or scaled up so that a middle point of the image data is centered, so that high visibility for the user can be realized.

In addition to the foregoing arrangement, the information display control device according to the present invention may be arranged so that the image data obtaining section causes the image data storage section to store display information whose range has been specified on the basis of an input indicative of a range specifying instruction given by the user.

According to the foregoing arrangement, the user himself/herself can select a range to be scaled down or scaled up. Thus, in scaling down or scaling up the image data, there is no unnecessary display portion and it is possible to scale down or scale up a display area desired by the user.

Further, as described above, a navigation device according to the present invention includes: the information display control device according to the present invention; a map information storage section serving as the information providing section for providing the map information as the display information; a display section controlled by the information display control device; an input section which allows an instruction given by the user to be inputted to the information display control device; and an image data storage section.

In addition to the foregoing arrangement, the navigation device according to the present invention may include a positional information measuring section for measuring positional information indicative of a current position, wherein: in case where the map information displayed in the display section includes the positional information indicative of the current position measured by the positional information measuring device, the changing display control means scales down or scales up the map information so that the current position is centered.

According to the foregoing arrangement, the map information is scaled down or scaled up so that the current position is centered. Thus, the user can obtain map information which allows the user to easily confirm a position, so that the device is usable for the user.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

The present invention is applicable to an information processing field in which image information including at least any one of letter data, graphic data, and diagram data is displayed. Particularly, the present invention can be used in an information processing device which scales down or scales up at least one of letters, graphics, and diagrams.

1. An information display control device, comprising:
information display control means for causing display information read out from an information providing section to be displayed in a display section;
image data obtaining means for converting at least the display information displayed in the display section into image data so as to cause an image data storage section to store the image data;
changing display control means for reading out the image data from the image data storage section and for scaling down or scaling up the image data so as to display the image data in the display section in response to a scale-down or scale-up changing instruction given by a user;
determined size information generation means for reading out the display information from the information providing section so as to convert the display information into determined size information by adjusting a scale-down or scale-up factor of the display image to a display scale factor specified in the scale-down or scale-up determination instruction given by the user; and
determined display control means for causing the display section to display the determined size information.

2. The information display control device as set forth in claim 1, wherein the changing display control means scales down or scales up the image data in response to an operation in which the user gives the scale-down or scale-up changing instruction.

3. The information display control device as set forth in claim, wherein:
when the display information includes vector font data,
the determined size information generation means calculates a size of the vector font data so as to correspond to the display scale factor, and converts the vector font data into determined size information having the size that has been calculated.

4. The information display control device as set forth in claim 1, wherein the display information is map information which includes at least any one of letter data, graphic data, and diagram data.

5. The information display control device as set forth in claim 4, wherein the image data obtaining means causes the image data storage section to store, as image data, not only the map information displayed in the display section but also map-peripheral information indicative of peripheral information of the map information.

6. The image display control device as set forth in claim 1, wherein the image data obtaining section causes the image data storage section to store only the display information displayed in the display section.

7. The information display control device as set forth in any one of claims 1, wherein:
in case where the display section has an area which does not display the image data read out, the changing display control means causes the display section to display an image serving as a background of the area.

8. The information display control device as set forth in claims 1, wherein the changing display control means scales down or scales up the image data so that a middle point of the image data is centered.

9. The information display control device as set forth in claims 1, wherein the image data obtaining section causes the image data storage section to store display information whose range has been specified on the basis of an input indicative of a range specifying instruction given by the user.

10. An information display control device, comprising:
display total control means for causing display information read out from an information providing section to be displayed in a display section; and
image data obtaining means for converting at least the display information displayed in the display section into image data so as to cause an image data storage section to store the image data, wherein:
the display total control means reads out the image data from the image data storage section and scales down or scales up the image data so as to display the image data, instead of the display information, in the display section in response to a scale-down or scale-up changing instruction given by a user, and
the display total control means reads out the display information from the information providing section and causes the display section to display, instead of the image data, determined size information obtained by converting the display information by adjusting a scale-down or scale-up factor of the display image to a display scale factor specified in the scale-down or scale-up determination instruction given by the user.

11. A navigation device, comprising:
the information display control device as set forth in claim 1;
a map information storage section serving as the information providing section for providing the map information as the display information;
a display section controlled by the information control device;
an input section which allows an instruction given by the user to be inputted to the information display control device; and
an image data storage section.

12. The navigation device as set forth in claim 11, comprising a positional information measuring section for measuring positional information indicative of a current position, wherein:
in case where the map information displayed in the display section includes the positional information indicative of the current position measured by the positional information measuring device,
the changing display control means scales down or scales up the map information so that the current position is centered.

13. A method for controlling an information display control device, comprising the steps of:
causing display information read out from an information providing section to be displayed in a display section;
converting at least the display information displayed in the display section into image data so as to cause an image data storage section to store the image data;
reading out the image data from the image data storage section and scaling down or scaling up the image data so as to display the image data in the display section in response to a scale-down or scale-up changing instruction given by a user;
reading out the display information from the information providing section so as to convert the display information into determined size information by adjusting a scale-down or scale-up factor of the display image to a display scale factor specified in the scale-down or scale-up determination instruction given by the user; and
causing the display section to display the determined size information.

14. A control program, causing the information display control device as set forth in claims 1 to operate, wherein the foregoing means are realized by a computer.

15. A computer-readable storage medium, storing the control program as set forth in claim 14.
